(19) United States
(12) Patent Application Publication
(10) Pub. No.: US 2014/0043815 A1
(43) Pub. Date: Feb. 13, 2014

(54) LIGHT EMITTING DIODE BULB STRUCTURE FOR ENHANCING HEAT DISSIPATION EFFICIENCY

(71) Applicant: Sheng-Yi CHUANG, Hsinchu City (TW)

(72) Inventor: Sheng-Yi CHUANG, Hsinchu City (TW)

(21) Appl. No.: 13/705,855

(22) Filed: Dec. 5, 2012

(30) Foreign Application Priority Data
Aug. 9, 2012 (TW) 101128711

(51) Int. Cl. F21V 29/00

(52) U.S. Cl. CPC F21V 29/2262
USPC 362/249.02

(57) ABSTRACT

A light emitting diode (LED) bulb structure includes a lamp shell, a light emitting assembly, a heat conducting body and a heat dissipating body. The light emitting assembly includes a light source substrate carrying at least one light emitting element. The heat conducting body includes a heat collecting portion contacting the light source substrate, a heat conducting portion connecting to the heat collecting portion, and multiple heat conducting fins extended radially and outwardly from the heat conducting portion. The heat dissipating body is formed on the heat conducting body through injection molding and includes multiple heat dissipating fins disposed on the surface thereof correspondingly to the heat conducting fins such that the heat conducting fins are encased therein. Accordingly, heat generated by the light source substrate is absorbed by the heat collecting portion and then conducted from the heat conducting fins to the heat dissipating fins for dissipation.

### FIELD OF THE INVENTION

The present invention relates to a light emitting diode (LED) lamp device, and particularly to an LED bulb structure for enhancing heat dissipation efficiency.

### BACKGROUND OF THE INVENTION

A light emitting diode (LED) is a semiconductor electronic element that is enabled to illuminate by electric energy. In an LED, rather than heating a tungsten wire to incandescence by a high current and high resistance, energy released from combining electrons and holes in the semiconductor is utilized as optic energy. Thus, compared to a conventional tungsten light bulb, an LED has advantages of being power saving, long in life cycle and high in brightness. Among various lamp devices using LEDs as light emitting elements, an LED bulb has the most preferred practicability. That is to say in addition to having a lamp shell similar to that of a conventional incandescent bulb as well as a power connection socket, an LED bulb further has benefits of an LED compared to a conventional incandescent bulb.

Therefore, LED bulbs are prevalent in many prior arts. However, by summarizing technical issues to be solved by the prior arts, an LED bulb encounters the following technical issues.

First of all, to increase brightness of a bulb, manufacturers are prone to dispose multiple LED chips on a light source substrate having a small area. In the event that heat generated by the chips cannot be efficiently dissipated, the chips may be degraded due to high temperature to shorten life cycle of the overall structure.

Secondly, to increase heat dissipation efficiency, conventional solution conducts the heat generated by the chips to an external metal heat dissipation seat which has a plurality of heat dissipating fins integrally formed thereon. However, the heat dissipating fins are made of a costly metal material that contradicts with an expected low cost of a consumable.

Further, in order to prevent a user from getting an electric shock caused by electric conduction of the metal heat dissipation seat through a high voltage, an insulation structure is often disposed between the metal heat dissipation seat and a circuit board. However, an extremely high voltage nevertheless breaks through the insulation structure such that the LED bulb still fails a high-voltage test.

The Taiwan Utility Model No. M394423 discloses a prior art for an LED lamp. The LED lamp comprises an LED module, a heat dissipating sheet with a porous structure, and a lamp socket made of a non-metal material. The heat dissipating sheet is coupled with the LED module at one end surface and coupled with the lamp socket at the other end surface. Heat generated by the LED module is conducted via the heat dissipating sheet to the lamp socket for dissipation. It should be noted that only part of the heat dissipating sheet, e.g., a periphery of the heat dissipating sheet, is coupled with the lamp socket. Thus the limited contact area results in degradation of heat conduction efficiency between the heat dissipating sheet and the lamp socket. In addition, as the lamp socket is made of a non-metal material, it also decreases the heat dissipation efficiency.

The Taiwan Publication No. 201144667 discloses another type of LED lamp device. The LED lamp device comprises a light emitting element carrying an LED chip, a heat conductive thermoplastic resin formed body having a load deflection temperature of above 100° C. and a volume resistivity of above 10³ Ω*cm, and a conductive member disposed on the thermoplastic resin formed body. Since the conductive member and the thermoplastic resin formed body are closely coupled, the LED lamp device is capable of overcoming a drawback of low heat conduction efficiency. However, as the conductive member has good electric conductivity, in the event that a high voltage is applied to the LED lamp device, a user could easily be exposed to hazards of an electric shock.

The Taiwan Utility Model No. M413814 discloses an LED heat dissipation module. The LED heat dissipation module comprises a fin seat cut out from a metal material, and a plurality of heat dissipating fins embedded in the fin seat. The fin seat comprises a flat plate and a surrounding sidewall encircling the flat plate. A heat conduction effect is reinforced as the flat plate and the surrounding sidewall are integrally cut out.

The U.S. Pat. No. 7,753,560 discloses an LED bulb. The LED bulb comprises a hollow cylindrical heat absorbing member, a plurality of LED modules disposed on an outer sidewall of the heat absorbing member, a heat sink positioned at the top of the heat absorbing member, and a plurality of heat dissipating pipes. Each of the heat dissipating pipes comprises an evaporating portion held within the inner sidewall of the heat absorbing member, and a condensing portion extended radially and outwardly from a center of the heat sink.

The China Publication No. CN102454907A discloses an LED light tube. The LED light tube comprises an LED sealing member, a diffuser, a heat sink, a power housing, a power supply and a screw lamp socket. The heat sink is directly attached to the LED sealing member to form a heat conducting path. The heat sink comprises a main body as a physical cavity, a plurality of fins extended radially from the main body, and a cover plate located above the fins to form a plurality of passive airflow pipes with the main body of the heat sink. Further, the cover plate has an upper hole and a lower hole allowing passive airflows to pass through the passive airflow pipes. Through the airflows passing through the airflow pipes, heat conducted from the LED sealing member to the heat sink can be removed.

Further, the US Publication No. 2011/0232886 discloses a heat dissipating shell of an LED lamp device. The heat dissipating housing comprises an accommodating channel axially provided in the heat dissipating housing. A plurality of heat dissipating fins are axially and outwardly extended along the heat dissipating housing such that the heat dissipating fins form a plurality of grooves at an accommodating channel side. Each of the heat dissipating fins has a plurality of parallel through holes through which heat in the heat dissipating fins performs heat exchange with cold air of the exterior. The width of the heat dissipating fins gradually expands from the accommodating channel side towards the side away from the accommodating channel side, so that an included angle is formed between sides of every two fins. With the included angles, dead angles of ventilation between adjacent fins can be eliminated to thereby enhance heat dissipation efficiency.

As described, the foregoing prior arts propose different structures for improving heat conduction efficiency of the LED bulb. However, the issue of an insufficient contact area between the heat dissipation module and the heat dissipating fins yet remains. Therefore, there is a need for a solution for further improving the heat dissipation efficiency of an LED bulb.

### SUMMARY OF THE INVENTION

Therefore a primary object of the present invention is to overcome issues of high costs and inferior heat dissipation efficiency of a heat dissipation seat in a conventional LED bulb.

A secondary object of the present invention is to overcome an issue of exposing a user to hazards of an electric shock due to high conductivity of a conventional heat dissipation module made of a metal material.

To achieve the above objects, an LED bulb structure for enhancing heat dissipation efficiency is provided according to the present invention. The LED bulb structure comprises a lamp shell, a light emitting assembly, a heat conducting body and a heat dissipating body. The light emitting assembly comprises a light source substrate disposed in the lamp shell and carrying at least one light emitting element, a circuit board electrically connected to the light source substrate, and a power connection socket receiving an external power and electrically connected to the circuit board. The heat conducting body comprises a heat collecting portion contacting the light source substrate, a heat conducting portion connected to the heat collecting portion, and a plurality of heat conducting fins extended radially and outwardly from a surface of the heat conducting portion. The heat dissipating body is formed on the heat conducting body through injection molding, and comprises a plurality of heat dissipating fins disposed on a surface thereof correspondingly to the heat conducting fins to encase the heat conducting fins therein. The heat dissipating body further comprises an accommodating space for accommodating the circuit board. Heat generated by the light source substrate is absorbed by the heat collecting portion, and is then conducted from the heat conducting fins to the heat dissipating fins for dissipation.

In an embodiment, the light source substrate is electrically connected to the circuit board via at least one conductive wire. The heat conducting body comprises at least one interconnecting hole penetrating through the heat collecting portion and allowing the conductive wire to extend from the light source substrate into the accommodating space.

In an embodiment, the accommodating space of the heat dissipating body holds an insulating body.

In an embodiment, the heat dissipating body comprises a carrying plane corresponding to the light source substrate, a connecting portion connecting to the power connection socket, and two retaining grooves formed on an inner wall of the heat dissipating body to hold the circuit board.

In an embodiment, the heat dissipating body comprises at least one positioning portion disposed on a periphery of the carrying plane, and the lamp shell comprises at least one wedging portion wedging into the positioning portion.

In an embodiment, the heat dissipating fins are integrally formed on the heat dissipating body and radially spaced from each other.

In an embodiment, the heat conducting fins are integrally formed on the heat conducting body and radially spaced from each other.

In an embodiment, surfaces of the heat conducting fins are completely encased by the heat dissipating fins.

In an embodiment, the heat dissipating body is consisted of a component (A) and a component (B) below.

The component (A) is a group selected from polyamide, polypropylene, polybutylene terephthalate, polyphthalamide, polycarbonate, polyarylene thioether, liquid crystal polymer, and syndiotactic polystyrene. The component (B) is a group selected from aluminum oxide, magnesium oxide, aluminum nitride, silicon carbide, talc and boron nitride.

In an embodiment, the heat conducting body is made of a material of a group or an alloy selected from gold, silver, copper, iron and aluminum.

In an embodiment, the heat collecting portion, the heat conducting portion and the heat conducting fins are formed on the heat conducting body by die-casting, aluminum extrusion or stamping.

The LED bulb structure for enhancing heat dissipation efficiency offers advantages of lower production costs, minimal hazards of an electric shock for a user and enhanced heat dissipation efficiency.

The heat dissipating body of the present invention is made of a mixture of a plastic material and ceramic powder and formed through injection molding. Compared to a conventional heat dissipating body made of a metal material, the heat dissipating body of the present invention offers lower production costs.

As previously stated, the heat dissipating body of the present invention is made of a mixture from a plastic material and ceramic power, and is lower in electric conductivity compared to a conventional heat dissipation module made of a metal material. Therefore, hazards of an electric shock caused by an electric leakage of circuit components in an LED are minimized for a user.

Moreover, the heat conducting body of the present invention comprises a plurality of heat conducting fins extended radially and outwardly from the surface of the heat conducting portion. Then the heat dissipating body is formed on the heat conducting body through injection molding, and comprises a plurality of heat dissipating fins disposed on the surface thereof correspondingly to the heat conducting fins, such that the heat dissipating fins completely encase the heat conducting fins therein. More specifically, the contact area between heat conducting body and the heat dissipating body is expanded via the heat conducting fins, and a surface area of the heat dissipating body exposed to the exterior is further increased by the heat dissipating fins. Consequently, heat absorbed by the heat conducting body from the light source substrate can be quickly conducted to the heat dissipating body, and then dissipated through the heat dissipating fins disposed on the surface of the heat dissipating body.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a first exploded view according to an embodiment of the present invention.

FIG. 2 is a second exploded view according to an embodiment of the present invention.

FIG. 3 is a partial sectional view according to an embodiment of the present invention (excluding a circuit board and an insulating body).

FIG. 4 is a sectional view according to an embodiment of the present invention.

### DETAILED DESCRIPTION OF THE PREFERRED EMBODIMENTS

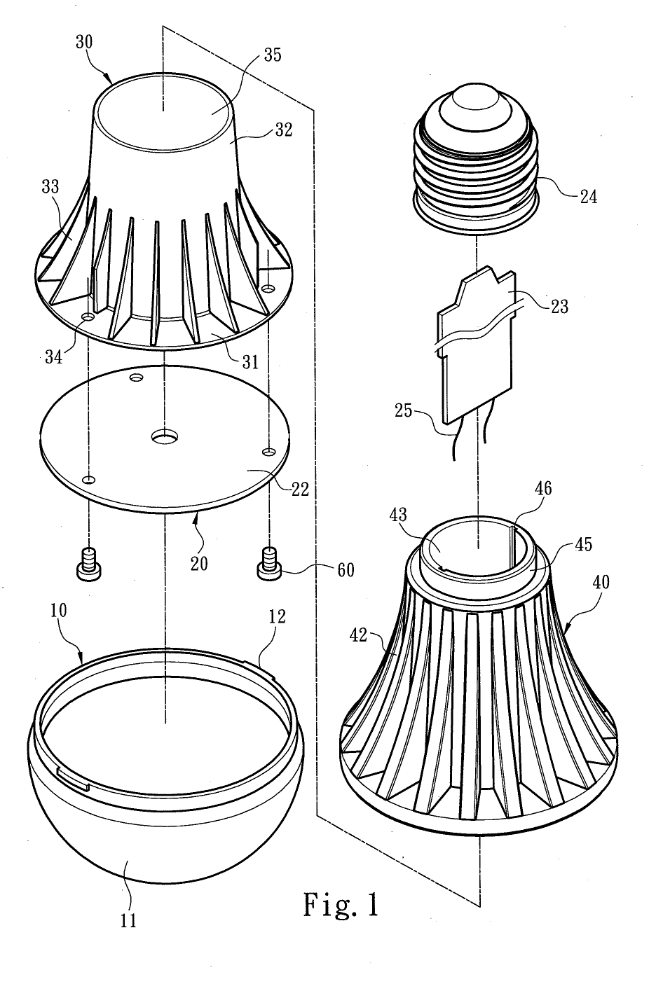

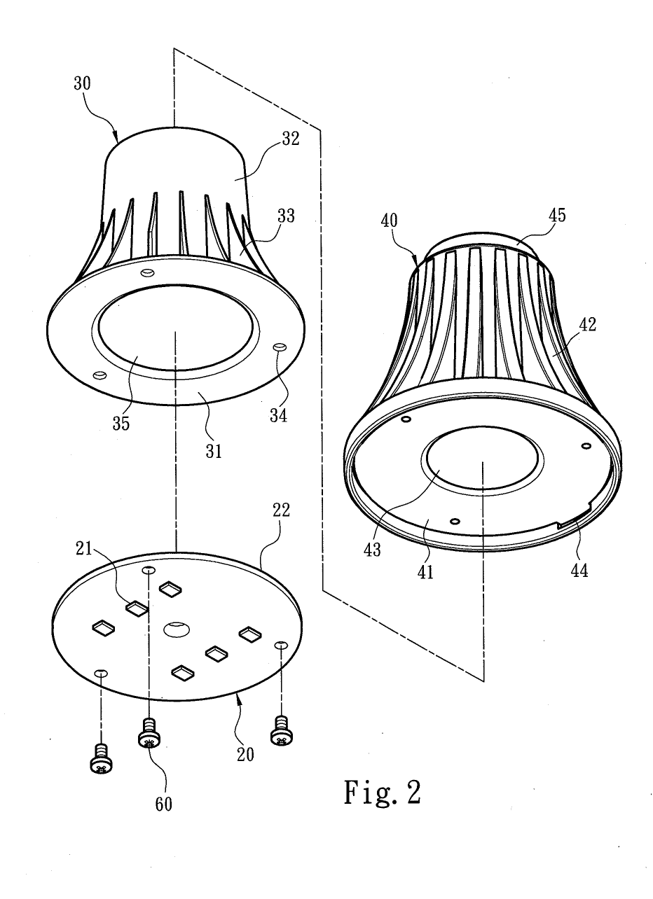

FIGS. 1 and 2 respectively show first and second exploded views of a light emitting diode (LED) bulb structure according to an embodiment of the present invention. Referring to FIGS. 1 and 2, the LED bulb structure for enhancing heat dissipation efficiency comprises a lamp shell 10, a light emitting assembly 20, a heat conducting body 30 and a heat dissipating body 40. The light emitting assembly 20 comprises a light source substrate 22 disposed in the lamp shell 10 and carrying at least one light emitting element 21, a circuit board 23 electrically connected to the light source substrate 22, and a power connection socket 24 receiving an external power and electrically connected to the circuit board 23.

The lamp shell 10 comprises a transmittance portion 11 and at least one wedging portion 12 extended from the transmittance portion 11. The heat dissipating body 40 comprises a carrying plane 41 corresponding to the light source substrate 22, and at least one positioning portion 44 disposed on a periphery of the carrying plane 41. The wedging portion 12 of the lamp shell 10 is wedged into the corresponding positioning portion 44 to steadily couple the lamp shell 10 with the heat dissipating body 40. In an embodiment of the present invention, the lamp shell 10 is formed in a semi-spherical or spherical shape, and may also be formed in an elliptical, flame or ice cream shape, or other shapes according to different design requirements.

On the surface of the light source substrate 22 carrying the light emitting element 21 is provided with a conductive wiring for supplying power to the light emitting element 21. The light source substrate 22 is electrically connected to two conductive wires 25 of the circuit board 23 which is further electrically connected to the power connection socket 24 to acquire the external power, so that the light emitting element 21 is powered to illuminate.

The heat dissipation structure of the present invention is described in detail below. The heat conducting body 30 comprises a heat collecting portion 31 in contact with the light source substrate 22, a heat conducting portion 32 connected with the heat collecting portion 31, and a plurality of heat conducting fins 33 extended radially and outwardly from a surface of the heat conducting portion 32. The purpose of the heat conducting fins 33 is for optimizing conduction efficiency of waste heat to the heat dissipating body 40 for the heat conducting body 30. To enhance the heat dissipation efficiency of the heat conducting body 30, the heat conducting body 30 is preferably made of a metal material having high heat conductivity, such as a group or an alloy selected from gold, silver, copper, iron and, and aluminum. The heat collecting portion 31, the heat conducting portion 32 and the heat conducting fins 33 are formed on the heat conducting body 30 by die-casting, aluminum extrusion or stamping. In an embodiment of the present invention, the heat conducting body 30 is made of aluminum. Details of the foregoing embodiment are an example for explaining the present invention and are not to be construed as limitations to the present invention.

To maximize the contact area between the heat conducting body 30 and the heat dissipating body 40, the heat dissipating body 40 is formed on the heat conducting body 30 through injection molding according to an embodiment of the present invention. In an implementation step according to an embodiment of the present invention, before the heat dissipating body 40 is molded through injection, the heat conducting body 30 is first disposed in a mold such that the heat conducting fins 33 of the heat conducting body 30 are wedged in the formed heat dissipating body 40. Thus, the heat dissipating fins 42 formed on the surface of the heat dissipating body 40 have structures and positions corresponding to the heat conducting fins 33. Accordingly, the heat dissipating fins 42 completely encase the heat conducting fins 33 therein. Further, the heat conducting fins 33 and the heat dissipating fins 42 are respectively spaced from each other radially, so that air can thoroughly flow among the heat dissipating fins 42 to quickly carry waste heat away. More specifically, the contact area between the heat conducting body 30 and the heat dissipating body 40 is expanded using the heat conducting fins 33, and a surface area of the heat dissipating body 40 exposed to the exterior is also increased by the heat dissipating fins 42. With auxiliary effects provided by the heat conducting fins 33 and heat dissipating fins 42, the heat dissipation efficiency of the LED bulb of the present invention is further enhanced.

While significantly enhancing the heat dissipation efficiency, overall production costs are lowered as the heat dissipating body 30 is not completely made of a metal material. Further, instead of being made of a pure metal material or an alloy, the material of the heat dissipating body 30 according to an embodiment of the present invention is made of a mixture of a plastic material (A) and ceramic power (B). The plastic material (A) may be one or a group selected from polyamide, polypropylene, polybutylene, terephthalate, polyphthalamide, polycarbonate, liquid crystal polymer, and syndiotactic polystyrene. The ceramic power (B) is one or a group selected from aluminum oxide, magnesium oxide, aluminum nitride, silicon carbide, talc and boron nitride. In an embodiment of the present invention, the plastic material is polycarbonate, for example. In addition to lowering production costs, the heat dissipating body made of a non-metal material has lower electric conductivity compared to a conventional heat dissipation module made of a metal material. Therefore, hazards of an electric shock caused by an electric leakage of circuit components in an LED are minimized when a user touches the heat dissipating body.

Again referring to FIGS. 1 and 2, in an embodiment of the present invention, the light source substrate 22 is fastened to the heat collecting portion 31 by a plurality of fastening elements 60 penetrating through a plurality of interconnecting holes 34. The heat generated by the light source substrate 22 due to the powered and illuminated light emitting element 21 is absorbed by the heat collecting portion 31, and then is conducted to the heat conducting fins 33 via the heat conducting portion 32 connected with the heat collecting portion 31. Next, the heat conducting fins 33 quickly conduct the heat to the heat dissipating fins 42 for dissipation. Accordingly, the LED bulb structure of the present invention offers an obstructed heat conduction path and a large-area heat dissipating surface, so that heat dissipation efficiency is significantly enhanced.

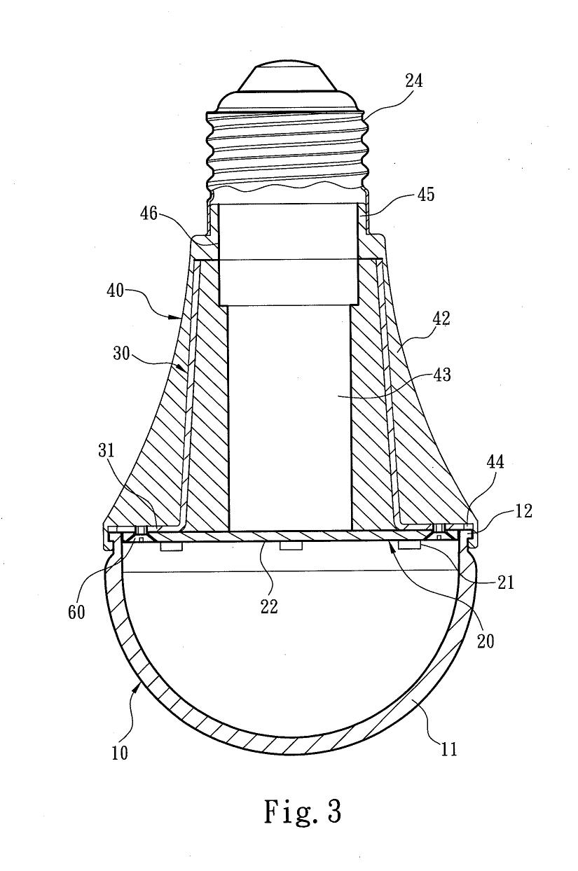

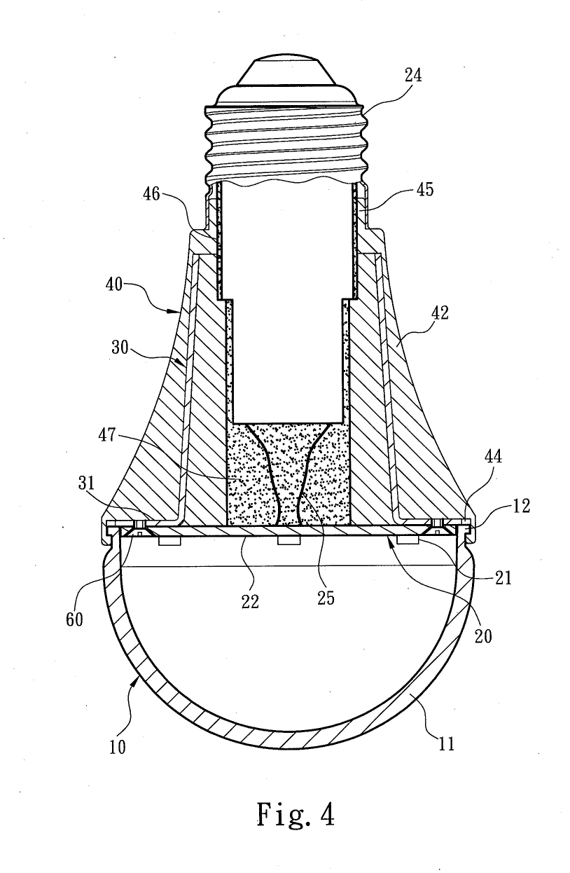

With reference to FIGS. 1 and 4, assembly details of the LED bulb structure of the present invention shall be described. It should be noted that, although the heat conducting body 30 and the heat dissipating body 40 appear as two separate and independent members in FIGS. 1 and 2, FIGS. 1 and 2 are exemplary drawings for clearly depicting that the heat conducting body 30 and the heat dissipating body 40 have corresponding structures. In practice, as the heat dissipating body 40 is formed on the heat conducting body 30 through injection molding, most of the heat conducting body 30 is encased within the heat dissipating body 40 such that the heat conducting body 30 and the heat dissipating body 40 are inseparable. For example, as shown in FIGS. 3 and 4, the heat conducting portion 32 and the heat conducting fins 33 of the heat conducting body 30 are all encased within the heat dissipating body 40, whereas only the heat collecting portion 31 is exposed outside the heat dissipating body 40 to be in contact with the light source substrate 22.

With respect to the structure of the heat dissipating body 40, the heat dissipating body 40 comprises an accommodating space 43 for accommodating the circuit board 23 and various electronic components, a connecting portion 45 for connecting the power connection socket 24, and two retaining grooves 46 formed on an inner wall of the heat dissipating body 40. The accommodating space 43 may be further provided with an insulating body 47. In an embodiment of the present invention, the insulating body 47 is a heat conduction resin filled in the accommodating space 43, such that the circuit board 23 or various electronic components electrically connected with the circuit board can be completely encased within the insulating body 47. Thus, the insulating body 47 serves as an insulation substance between the circuit board 23 and the electronic components from the heat dissipating body 40. By preventing the foregoing circuit leakage that conducts a high voltage to the heat dissipating body 40, utilization safety of the present invention is further increased. In addition, the insulating body 47 further conducts waste heat generated by the circuit board 23 and the electronic components to the heat dissipating body 40. Further, the power connection socket 24 is fastened to the connecting portion 45 by a mechanical means. The circuit board 23 is electrically connected to the power connection socket 24 to connect to an external AC power source, and rectifies the AC power to a DC power for powering the light emitting element 21 to emit light. It should be noted that the foregoing assembly means is an example according to an embodiment of the present invention, and modifications can be made by a person having ordinary skill in the art, as such modifications are within the scope of the present invention.

In conclusion, the LED bulb structure for enhancing heat dissipation efficiency provided by the present invention comprises a heat conducting body made of a metal material, and a heat dissipating body made of a mixture from a plastic material and ceramic powder. The heat conducting body comprises a plurality of heat conducting fins extended radially and outwardly from a surface of the heat conducting portion. After the heat dissipating body is formed on the heat conducting body through injection molding, the heat dissipating fins are formed on the surface of the heat dissipating body correspondingly to the heat conducting fins. Through the foregoing structure of the present invention, a non-metal mixed plastic material is utilized to replace a metal material for the heat dissipating body to lower production costs and hazards of an electric shock, while heat conduction efficiency between the heat conducting fins and the heat dissipating fins also is enhanced through close contact between them. Therefore, the LED bulb structure of the present invention achieves objects of low costs, high safety and satisfactory heat dissipating efficiency.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A light emitting diode (LED) bulb structure for enhancing heat dissipation efficiency, comprising:
a lamp shell;
a light emitting assembly, comprising a light source substrate disposed in the lamp shell and carrying at least one light emitting element, a circuit board electrically connected to the light source substrate, and a power connection socket receiving an external power and electrically connected to the circuit board;
a heat conducting body, comprising a heat collecting portion contacting the light source substrate, a heat conducting portion connected to the heat collecting portion, and a plurality of heat conducting fins extended radially and outwardly from a surface of the heat conducting portion;
a heat dissipating body, being formed on the heat conducting body through injection molding, comprising a plurality of heat dissipating fins disposed on a surface thereof correspondingly to the plurality of heat conducting fins such that the plurality of heat dissipating fins encase the plurality of heat conducting fins therein, and an accommodating space for accommodating the circuit board; wherein heat generated by the light source substrate is absorbed by the heat collecting portion and conducted from the plurality of heat conducting fins to the plurality of heat dissipating fins for dissipation.

2. The LED bulb structure for enhancing heat dissipation efficiency of claim 1, wherein the light source substrate is electrically connected to the circuit board via at least one conductive wire, and the heat conducting body comprises at least one interconnecting hole penetrating the heat collecting portion and allowing the at least one conductive wire to extend from the light source substrate into the accommodating space.

3. The LED bulb structure for enhancing heat dissipation efficiency of claim 1, wherein the accommodating space of the heat dissipating body holds an insulating body to encase the circuit board.

4. The LED bulb structure for enhancing heat dissipation efficiency of claim 1, wherein the heat dissipating body comprises a carrying plane corresponding to the light source substrate, a connecting portion connecting to the power connection socket, and two retaining grooves formed on an inner wall of the heat dissipating body to hold the circuit board.

5. The LED bulb structure for enhancing heat dissipation efficiency of claim 4, wherein the heat dissipating body comprises at least one positioning portion disposed on a periphery of the carrying plane, and the lamp shell comprises at least one wedging portion wedging into the at least one positioning portion.

6. The LED bulb structure for enhancing heat dissipation efficiency of claim 1, wherein the plurality of heat dissipating fins are integrally formed on the heat dissipating body and radially spaced from each other.

7. The LED bulb structure for enhancing heat dissipation efficiency of claim 1, wherein the plurality of heat conducting fins are integrally formed on the heat conducting body and radially spaced from each other.

8. The LED bulb structure for enhancing heat dissipation efficiency of claim 1, wherein surfaces of the plurality of heat conducting fins are completely encased by the plurality of heat dissipating fins.

9. The LED bulb structure for enhancing heat dissipation efficiency of claim 1, wherein the heat collecting portion, the heat conducting portion and the plurality of heat conducting fins are formed on the heat conducting portion by die-casting, aluminum extrusion or stamping.
